(19) United States
(12) Patent Application Publication
(10) Pub. No.: US 2006/0129839 A1
(43) Pub. Date: Jun. 15, 2006

(54) Flexchip-mounted fingerprint sensor

(76) Inventors: Jun Ye, San Diego, CA (US); Dejun Huang, San Diego, CA (US); Christopher Thomas, San Diego, CA (US)

Correspondence Address: Karl M. Steins;Steins & Associates, Suite 120, 2333 Camino del Rio South, San Diego, CA, 92108, US

(21) Appl. No.: 11/302,857

(22) Filed: Dec. 13, 2005

Related U.S. Application Data
(60) Provisional application No. 60/635,914, filed on Dec. 13, 2004.

(51) Int. Cl. H04K 1/00

(52) U.S. Cl. 713/186

(57) ABSTRACT

A Flexchip-mounted Fingerprint Sensor is disclosed. Also disclosed is a sensor that applies flexchip-mounting techniques in a novel way that creates substantially versatility and cost savings in the resultant fingerprint sensor. Rather than employing a conventional transmitter ring separate from a receiver integrated circuit, the device employs a transceiver integrated circuit, such that the IC is both the transmitter and the receiver of the scanning signals. The device further includes a method for protecting the transceiver device that includes the application of a protective coating to the integrated circuit in advance of assembly of the entire sensor.

### BACKGROUND OF THE INVENTION

The present invention claims priority to, and is filed within one year from Provisional Application for Pat. Ser. No. 60/635,914 filed Dec. 13, 2004.

1. Field of the Invention

This invention relates generally to fingerprint sensor devices and, more specifically, to a Flexchip-Mounted Fingerprint Sensor.

2. Description of Related Art

Fingerprint sensors are an up and coming technology that experts believe will be of significant importance in the portable device industry. While in the past, the detecting and analyzing of fingerprints was used predominantly for facility security and other building-related applications, in the future it's expected that most of today's personal electronic devices will include a fingerprint sensor capability. The portable device will require fingerprint sensing in order to validate the user's identity for the purpose of security of data and/or confirmation of identity for the purposes of financial transactions.

If we now turn to FIG. 1, we can examine how a conventional fingerprint sensor assembly is put together. FIG. 1 is an exploded partial cutaway view of a conventional fingerprint sensor assembly. The Conventional RF Fingerprint Assembly 10 has three major parts: a Printed Circuit Board 14, a Fingerprint Sensor Chip 12 (which is, in this depicted version, a sensor employing RF technology), and a Transmitter/Mounting Ring 16. In the Conventional Assembly 10, the Sensor Chip 12 is defined by a plurality of metallic Leads 18 protruding from the sides or bottom of the Chip 12. The Chip 12 is mounted to the Printed Circuit Board 14 by first inserting the Leads 18 into Contact Apertures 20 formed on or in the Printed Circuit Board 14, after which solder is applied.

Once the Chip 12 has been electrically bonded to the Printed Circuit Board 14, the Transmitter/Mounting Ring 16 is attached to the Chip 12. The Ring 16 comprises one or more RF transmitter ring(s) 22. The Transmitter Ring or Rings 22 are encased within a Ring Casing 24 that serves to protect both the Transmitter Ring 22 and the Sensor 12.

If we now turn to FIG. 2, we can see how this Assembly 10 looks when completed. FIGS. 2A and 2B are perspective views of the fingerprint sensor assembly of FIG. 1. As shown in FIG. 2A, the Transmitter Mounting Ring 16 is formed with an Aperture 26 in its center area. As such, the Ring 16 is configured to expose the top of the Sensor Chip 12 while covering the outer edges and/or Leads 18. When assembled, therefore, and as shown in FIG. 2B, the Sensor Chip 12 can be reached through the Aperture 26 formed in the Ring 16.

There are several problems with the Conventional Fingerprint Sensor Assembly 10. First, due to the number of Leads 18 required to obtain the necessary resolution of the scanned fingerprint, a substantial cost is involved in manufacturing a conventional Chip 12 and electrically bonding it to the Printed Circuit Board 14. Furthermore, since the Transmitter Mounting Ring 16 is so large and thick, it inhibits widespread use of the Assembly 10 on the smallest of portable electronic devices. In fact, these defects in the prior Assembly 10 result in severe limitations to the practicality of the Assemblies 10.

Now we will turn to FIG. 3 and begin discussion of another technical field. FIG. 3 is an exploded perspective view of a conventional flexchip-mounted LCD assembly. The mounting of liquid crystal displays has been improved in order to enable liquid crystal displays to be used in portable electronic devices. FIG. 3 shows a conventional Flexchip-Mounted LCD Assembly 30. It should be noted that while liquid crystal display devices are used on portable electronic equipment, since the location and electrical connectivity requirements are substantially different than that for a fingerprint sensor, it is believed that the display field is not analogous to the fingerprint sensor field.

When designed for use in cellular phones and the like, the Flexchip-Mounted LCD Assembly 30 comprises a Liquid Crystal Display Device Package 32, which is attached to a Flexible Circuit Board 42. The Device 32 is a Liquid Crystal Display Chip 34 that is contained within a typically non-conductive Package 36. The Package 36 is defined by a Termination Region 38, which is the location at which the Flexible Circuit Board 42 is attached to the Package 36 in a way that creates electrical connections between the Leads 44 that are contained within the Flexible Circuit Board 42 and the Contacts 40 that protrude from the surface of the Package 36.

The conventional Liquid Crystal Display Device Package 32 will typically require one or more Driver Devices 46 in order to support the operation of the liquid crystal display. The Driver and other auxiliary devices 46 are actually attached to the surface of this Flexible Circuit Board 42. As with the Package 36 attachment to the Flexible Circuit Board 42, a Driver Device 46 is also attached by bonding to the surface of the Flexible Circuit Board 42, such that there is electrical connectivity between the Leads 44 and the contacts on the bottom surface of the Device 46. In these cases, however, a Protective Resin 48 is generally applied atop and around the Device 46 in order to maintain connection between the Device 46 and the Flexible Circuit Board 42, and further to protect the surface of the Driver Device 46.

### SUMMARY OF THE INVENTION

In light of the aforementioned problems associated with the prior devices and methods, it is an object of the present invention to provide a Flexchip-Mounted Fingerprint Sensor. The sensor should apply flexchip-mounting techniques in a novel way that creates substantially versatility and cost savings in the resultant fingerprint sensor. Rather than employing a conventional transmitter ring separate from a receiver integrated circuit, the device should employ a transceiver integrated circuit, such that the IC is both the transmitter and the receiver of the scanning signals. The device should further include a method for protecting the transceiver device that applies a protective coating to the integrated circuit in advance of assembly of the entire sensor.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is an exploded partial cutaway view of a conventional fingerprint sensor assembly;

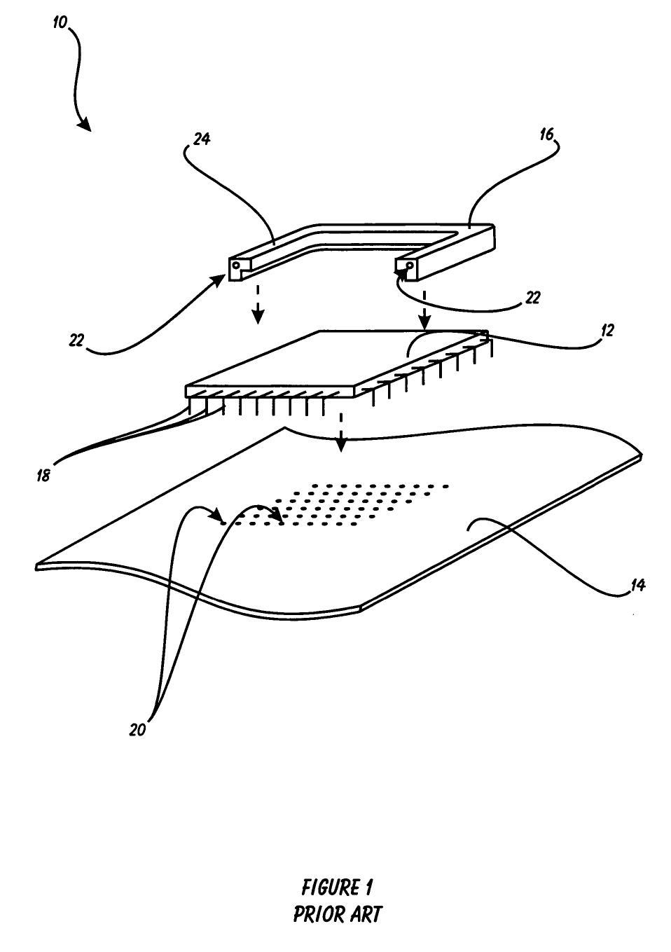

FIGS. 2A and 2B are perspective views of the fingerprint sensor assembly of FIG. 1;

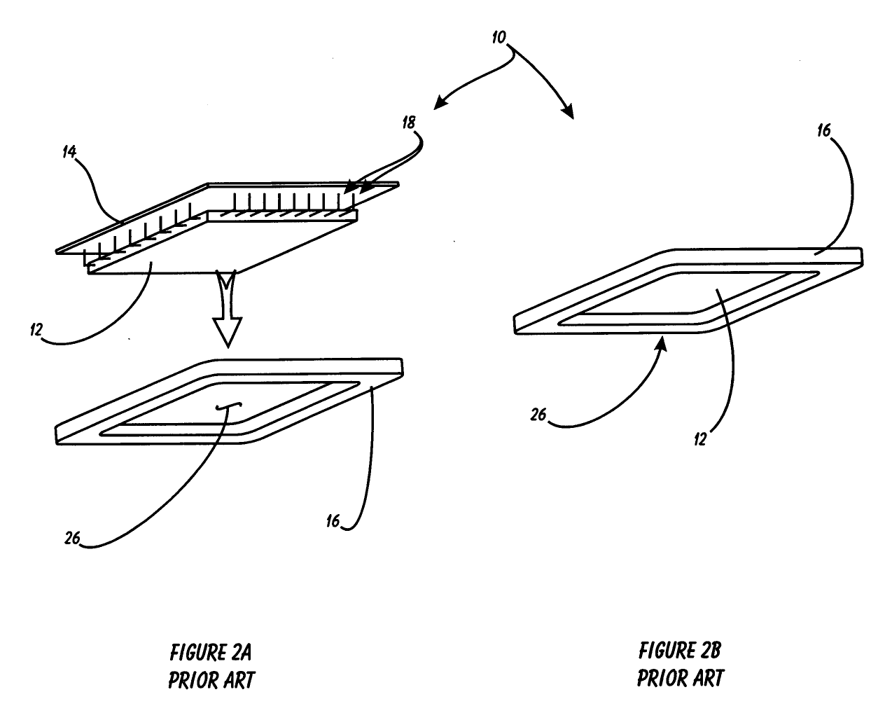

FIG. 3 is an exploded perspective view of a conventional flexchip-mounted LCD assembly;

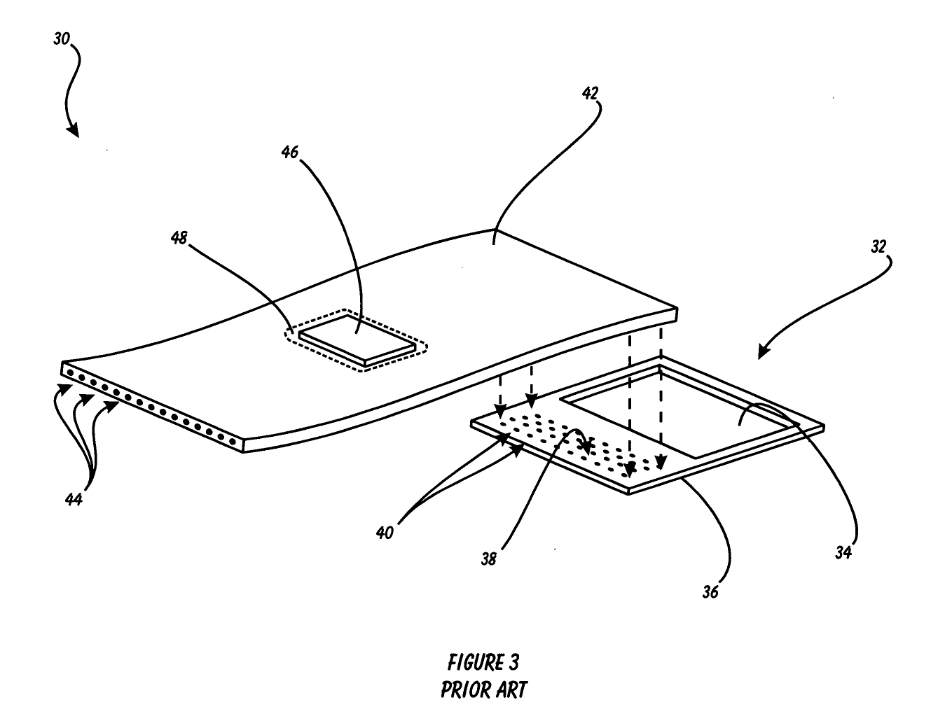

FIG. 4 is an exploded perspective view of a preferred embodiment of the flexchip-mounted fingerprint sensor of the present invention;

FIG. 5 is a perspective view of the sensor of FIG. 4;

FIG. 6 is a cutaway side view of the sensor of FIGS. 4 and 5; and

FIG. 7 is a top view of the sensor device of FIGS. 4-6.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Flexchip-mounted Fingerprint Sensor.

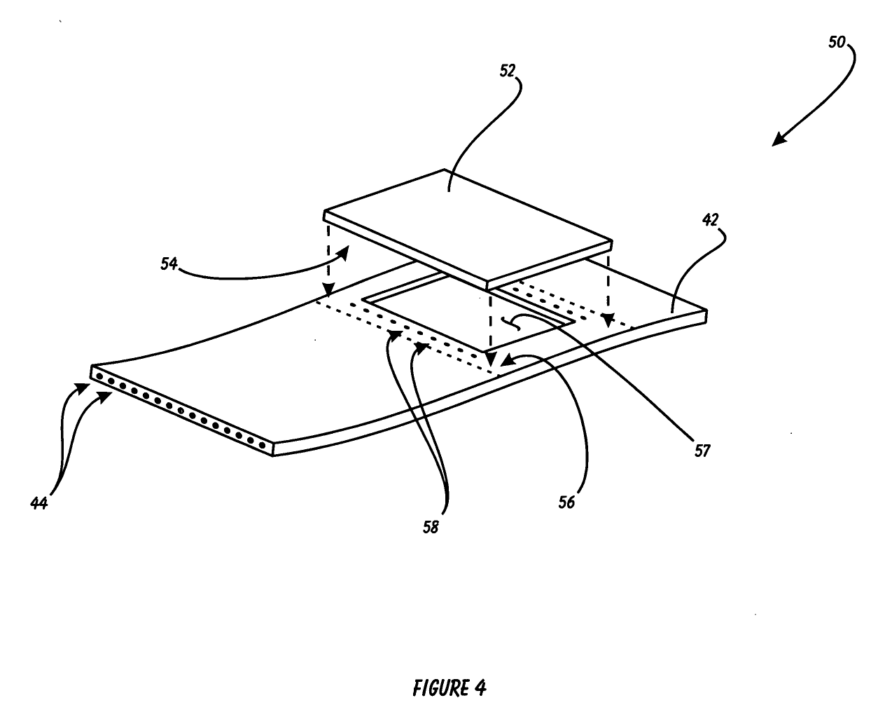

The present invention can best be understood by initial consideration of FIG. 4. FIG. 4 is an exploded perspective view of a preferred embodiment of the flexchip-mounted fingerprint sensor 50 of the present invention. The Flexchip Mounted Fingerprint Sensor 50 comprises a Flexible Circuit Board 42 and a Fingerprint Transceiver Device 52. The Flexible Circuit Board 42 is designed in a conventional manner and is essentially a plurality of flexible Leads 44 that are encased in a flexible ribbon. In creating the Sensor 50, a Termination Region 56 is defined on the Flexible Circuit Board 42. An Aperture 57 is cut or otherwise formed within the confines of the Termination Region 56. The Region 56 has a plurality of Contacts 58 dispersed on it, adjacent to the outer perimeter of the Aperture 57. They correspond to the locations of Contacts 54 defined on the top surface of the Fingerprint Transceiver Device 52. The Fingerprint Transceiver Device 52 is then attached to Flexible Circuit Board 42 via a means that will be discussed more fully later, at the end of which the Contacts 54 are electronically bonded to the Contacts 58 and the bottom surface of the Transceiver Device 52 is bonded to the surface of the Flexible Circuit Board 42 adjacent to the Aperture 57, and within the Termination Region 56.

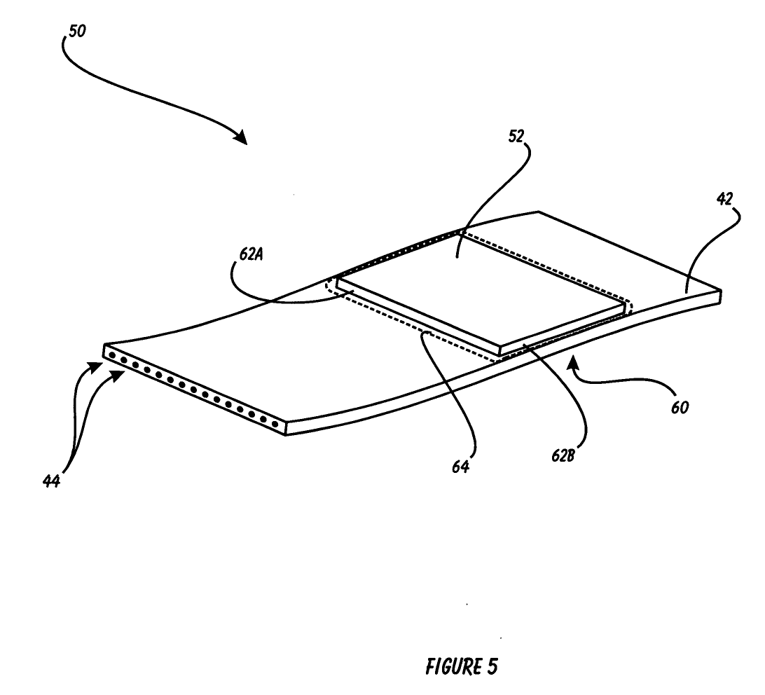

Now turning to FIG. 5, we can see how the completed package appears. FIG. 5 is a perspective view of the sensor of FIG. 4. The Flexchip-Mounted Fingerprint Sensor 50 when completely assembled comprises a Fingerprint Transceiver Device 52 attached to a Flexible Circuit Board 42. It should be understood that while the Circuit Board 42 is depicted here as extending beyond the two sides of the Device 52, this is simply for the purposes of illustration. It is expected that the Circuit Board 42 would be trimmed as necessary so that only that much of the Board 42 is left to provide connection between the Sensor 52 and the host devices electronics.

Once the Device 52 has been attached to the Circuit Board 42, it is further bonded to the Circuit Board 42 by applying a Resin 64. The distinction between this Resin 64 and that of the prior art attachment method is that this Resin 64 is applied around the perimeter of the Device 52, but is intentionally not applied to the Top Surface 60 of the Device 52. The Top Surface 60 is left uncovered in order to prevent insulation or other interference with the transmission and receipt of data by the Sensor 52.

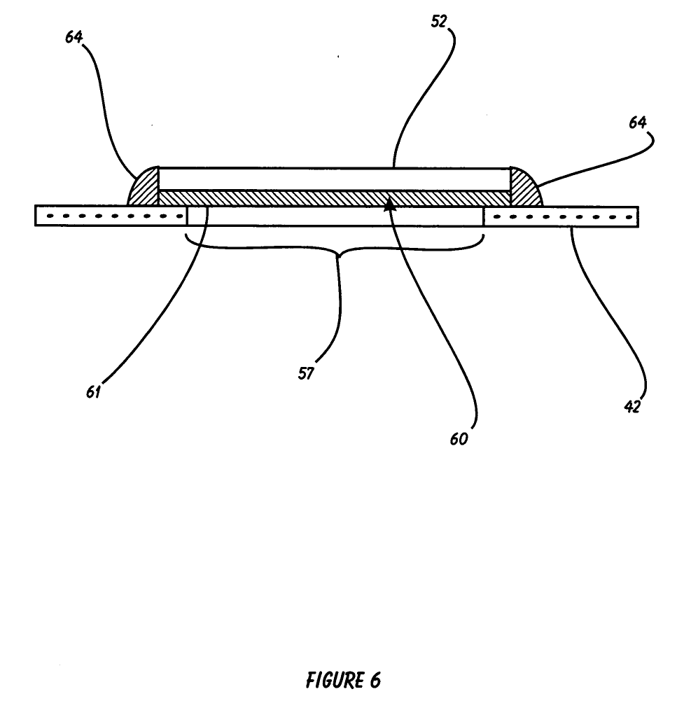

If we now turn to FIG. 6, we can examine further detail regarding this Fingerprint Sensor 50. FIG. 6 is a cutaway side view of the sensor of FIGS. 4 and 5. As shown from the side, we can see the sandwich design that is the Sensor 50 with a Flexible Circuit Board 42 and the Transceiver Device 52 bonded to one another such that the Contacts 54 and 58 make good electrical connection. The Top Surface 60 of the Device 52 further includes a novel Protective Coating 61 that has been applied after manufacturing of the Device 52, but typically prior to the attachment of the Device 52 to the Flexible Circuit Board 42. A Resin 64 is then applied around the perimeter of the Device 52 without the deposit of Resin 64 on the Top Surface 60. As depicted, the Top Surface 60 of the coated Device 52 is exposed through the Aperture 57. It is across this Aperture 57 that the user's finger is placed or swiped in order to scan the fingerprint.

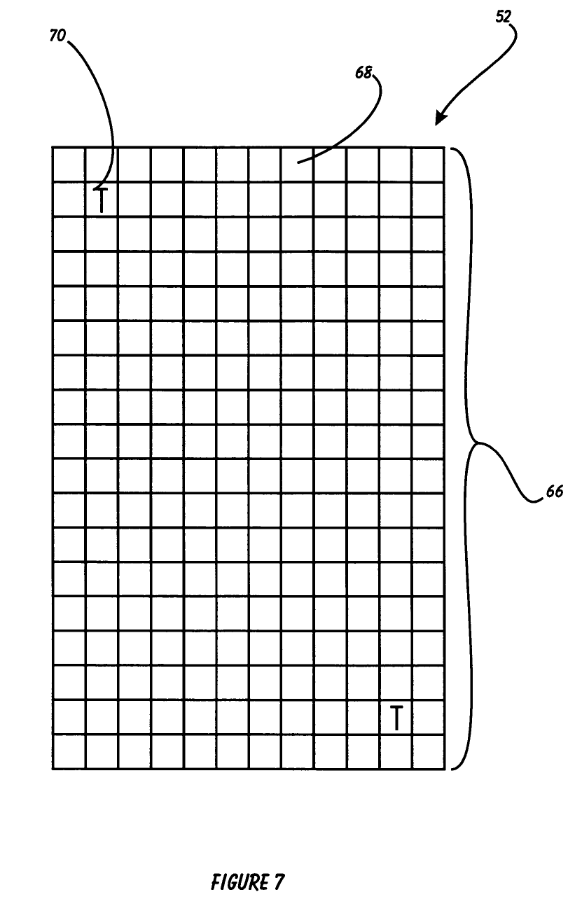

Finally, we will turn to FIG. 7 to understand yet another unique aspect of the present invention. FIG. 7 is a top view of the sensor device of FIGS. 4-6. The Fingerprint Sensor Device 52 of FIG. 7 is defined by a Detector/Transmitter Array 66. The Array 66 is comprised of a plurality of cells. Most of the cells in the Array 66 are Detector Cells 68 for detecting reflected RF signals from the scanned person's finger. In addition to the Detector Cells 68, one or more Transmitter Cells 70 are also dispersed in the Array 60. The Transmitter Cells 70 serve the purpose that was conventionally served by the prior art transmitter ring(s). By combining the Transmitter Cells 70 into the Detector/Transmitter Array 66, the overall package cost for the sensor has been reduced substantially, and furthermore the size of the package has been reduced substantially and, therefore, the use cases for the device have been expanded dramatically.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A fingerprint sensor combination, the combination comprising:
a modified flexible circuit board comprising a series of conductive leads encased in a flat, flexible, non-conductive casing, said flexible circuit board further comprising an aperture formed through said leads and said casing; and
a fingerprint transceiver device bonded to said flexible circuit board juxtaposed over said aperture.

2. The combination of claim 1, wherein said transceiver device further comprises a detector/transmitter array disposed on a top side of said transceiver device; and
said transceiver device is bonded to said casing with said top surface facing said casing and said juxtaposed aperture.

3. The combination of claim 2, wherein said transceiver device further comprises a plurality of contacts protruding from said top side adjacent to a peripheral edge defined by said device; and
said flexible circuit board further comprises a plurality of contacts dispersed around said aperture, each said contact in electrical communication with a said conductive lead, said transceiver device contacts bonded electrically to said flexible circuit board contacts.

4. The combination of claim 3, wherein said top side of said device further comprises a protective coating applied thereto.

5. The combination of claim 4, wherein said device is bonded to said flexible circuit board with a resin applied to surround said peripheral edge.

6. The combination of claim 5, wherein said detector/transmitter array is viewable through said aperture formed in said flexible circuit board.

7. A method for creating a fingerprint sensor assembly, the method comprising the steps of:
obtaining a fingerprint transceiver device defined by a detector/transmitter array disposed on a top surface of said device;
obtaining a modified a flexible circuit board, said flexible circuit board comprising a series of leads arranged to run longitudinally in a flat, flexible, non-conductive case, said modifying comprising forming an aperture through said casing and said leads; and
bonding said transceiver device to said flexible circuit board with said detector/transmitter array viewable through said aperture.

8. The method of claim 7, wherein said device obtaining step comprises obtaining a transceiver device further comprising a plurality of contacts protruding from said top side between a periphery of said detector/transmitter array and a peripheral edge of said device.

9. The method of claim 8, wherein said modifying step further comprises exposing a plurality of said leads adjacent to said aperture.

10. The method of claim 9, wherein said bonding step comprises electrically bonding said device contacts to said exposed leads.

11. The method of claim 10, wherein said device obtaining step comprises obtaining a transceiver device further comprising a protective coating applied over the portion of said detector/transmitter array viewable through said aperture, said protective coating being applied prior to said bonding.

12. The method of claim 11, wherein said bonding step further comprises applying a resin to surround said device and bond it to said flexible circuit board.

13. A fingerprint sensor assembly comprising:
a modified flexible circuit board comprising a series of conductive leads encased in a flat, flexible, non-conductive casing, said flexible circuit board further comprising an aperture formed through said leads and said casing; and
a fingerprint transceiver device further comprising a detector/transmitter array disposed on a top surface of said device, said device bonded to said flexible circuit board juxtaposed over said aperture to make said detector/transmitter array viewable through said aperture.

14. The assembly of claim 13, wherein said transceiver device is bonded to said casing with said top surface facing said casing and said juxtaposed aperture.

15. The assembly of claim 14, wherein said transceiver device further comprises a plurality of contacts protruding from said top side adjacent to a peripheral edge defined by said device; and
said flexible circuit board further comprises a plurality of contacts dispersed around said aperture, each said contact in electrical communication with a said conductive lead, said transceiver device contacts bonded electrically to said flexible circuit board contacts.

16. The assembly of claim 15, wherein said top side of said device further comprises a protective coating applied thereto.

17. The assembly of claim 16, wherein said device is bonded to said flexible circuit board with a resin applied to surround said peripheral edge.
